(19) United States
(12) Patent Application Publication
(10) Pub. No.: US 2004/0252124 A1
(43) Pub. Date: Dec. 16, 2004

(54) Video graphic array (VGA) device with a common scaling circuit

(76) Inventor: Shao-Tsu Kung, Taipei (TW)

Correspondence Address: Han-Yi Lee, BAYSHORE PATENT GROUP, LLC., 520 Chantecler Dr., Fremont, CA, 94539, US

(21) Appl. No.: 10/850,785

(22) Filed: May 21, 2004

(30) Foreign Application Priority Data
Jun. 13, 2003 (TW) 092116045

(51) Int. Cl. G06T 1/00; G06F 15/00

(52) U.S. Cl. 345/501

(57) ABSTRACT

The video graphic array (VGA) device comprises: a 2D/3D processing engine to deal with input graphic/text data; and a decompressing processing engine to deal with decompressing of input video compressed data. The device is characterized by that: a scaling circuit is common to the 2D/3D processing engine and the decompressing processing engine to receive the data processed by the 2D/3D processing engine and the data processed by the decompressing processing engine.

### FIELD OF THE INVENTION

The present invention is related to a video graphic array (VGA) device, and especially to a video graphic array device with a common scaling circuit.

### BACKGROUND OF THE INVENTION

As shown in FIG. 1 which is a schematic view of a conventional video graphic array (VGA) device 10, the conventional video graphic array (VGA) device 10 mainly comprises a 2D/3D processing engine 101 and a decompressing processing engine 103; generally, the internal circuit of the decompressing processing engine 103 includes a scaling circuit 103a that has the scaling function on the video data after decompressing and is unable to give any help for the 2D/3D processing engine 101. Thereby when the 2D/3D processing engine 101 is in need of scaling, another scaling circuit must be provided in the 2D/3D processing engine 101 to satisfy the requirement of processing for scaling of the 2D/3D processing engine 101. However, the mode of solving by adding the new scaling circuit will result overly high cost although it can get rid of the problem.

In view of the defect resided in the conventional art, the inventor of the present invention provides a simplified video graphic array device to get rid of the defect without losing the function or affecting the effect that a conventional video graphic card has had.

### SUMMARY OF THE INVENTION

The primary object of the present invention is to provide a simplified video graphic array device with a common scaling circuit to get rid of the defect resided in the conventional art without losing the function or affecting the effect that a conventional video graphic card has had.

To get the object, the present invention provides a simplified video graphic array (VGA) device comprising: a 2D/3D processing engine to deal with input graphic/text data and a decompressing processing engine to deal with decompressing of input video compressed data. The device is characterized by that: a scaling circuit is common to the 2D/3D processing engine and the decompressing processing engine to receive the data processed by the 2D/3D processing engine and the data processed by the decompressing processing engine.

The present invention will be apparent in its object, features and effects after reading the detailed description of the preferred embodiment thereof in reference to the accompanying drawings.

### BRIEF DESCRIPTION OF THE DRAWINGS

FIG. 1 is a schematic view showing the device of a conventional video graphic array (VGA) device;

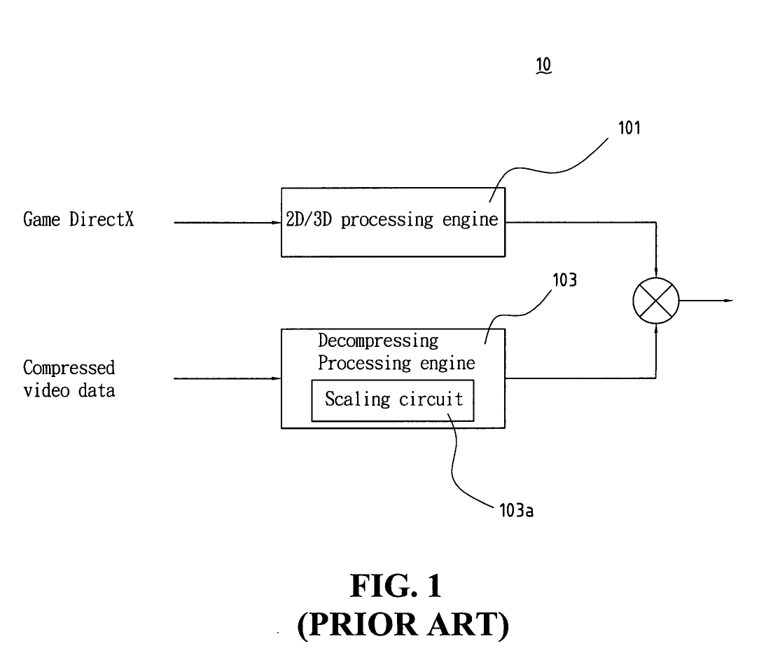

FIG. 2 is a schematic view showing the device of a video graphic array (VGA) device of the present invention.

### DETAILED DESCRIPTION OF THE INVENTION

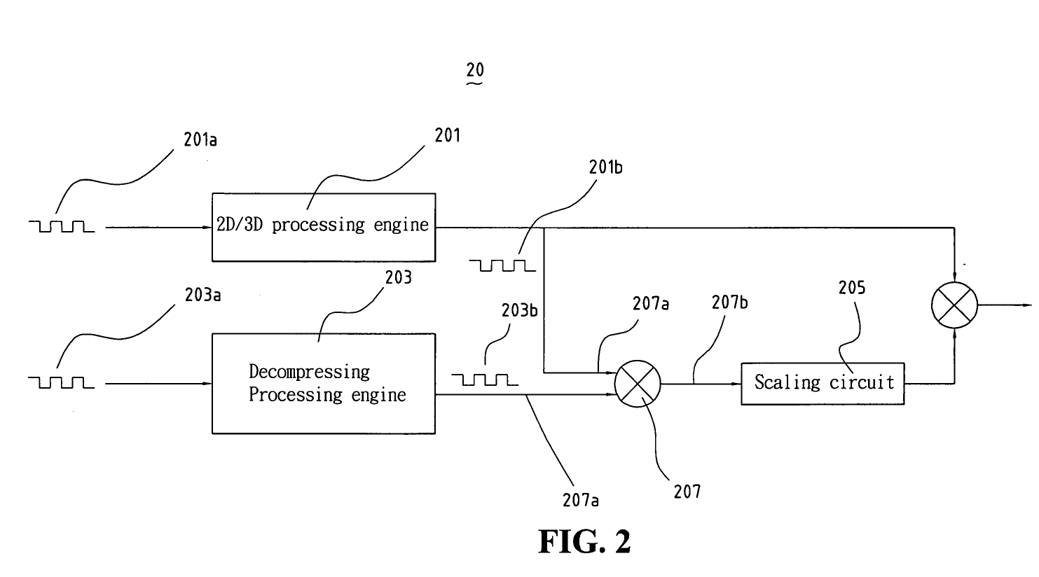

Referring to FIG. 2 showing a video graphic array 20 (VGA) device of the present invention, the device mainly comprises: a 2D/3D processing engine 201 to deal with input graphic/text data 201a, a decompressing processing engine 203 to deal with decompressing of input video compressed data 203a, and a scaling circuit 205 common to the 2D/3D processing engine 201 and the decompressing processing engine 203 to respectively receive data 201b processed by the 2D/3D processing engine 201 and data 203b processed by the decompressing processing engine 203. The most important feature of the present invention is that the scaling circuit 205 is common to the 2D/3D processing engine 201 and the decompressing processing engine 203. Therefore, the decompressing processing engine 203 needs not to be provided with an additional scaling circuit in itself, it can directly use the scaling circuit 205; and if the 2D/3D processing engine 201 is needed to further provide a function of scaling, this can also be dealt with directly by the scaling circuit 205. In the video graphic array 20 (VGA) device of the present invention, internal circuits of the 2D/3D processing engine 201 and the decompressing processing engine 203 do not have specific scaling circuits of them proper, their function of scaling are completely provided by the common scaling circuit 205.

The video graphic array 20 (VGA) device of the present invention can further be provided with a multiplexer 207, an input end 207a of the multiplexer 207 is connected to the output end of the 2D/3D processing engine 201 and the output end of the decompressing processing engine 203 respectively, an output end 207b of the multiplexer 207 is connected to the input end of the scaling circuit 205. Thereby, the video graphic array 20 (VGA) device of the present invention is processed in a multiplex mode to make the scaling circuit 205 do scaling works required by the 2D/3D processing engine 201 and the decompressing processing engine 203 in a multiplex mode.

The internal circuits of the 2D/3D processing engine 201, the decompressing processing engine 203 and the multiplexer 207 of the video graphic array 20 (VGA) device of the present invention have their respective measures of practicing, and can all directly use the technique of a conventional VGA.

The above stated mode of practicing for the video compressed data 203a are one kind from the three including MPEG1 video compressed data, MPEG2 video compressed data and MPEG4 video compressed data particularly. While the input graphic/text data 201a particularly are data generated from an application program of a game, or are data generated from an application program written by Direct X of the Microsoft Company, or generated from an application program of document processing, or from an application program of graphic processing.

By the main feature of having the common scaling circuit 205 of the video graphic array 20 (VGA) device of the present invention, it is evident that the video graphic array 20 (VGA) device can more easily make its circuits simplified without losing the function or affecting the effect that a conventional video graphic card has had, this largely reduce the gatecount of chips, and thereby can have the effect of saving electric power and reducing cost of production.

It will be apparent to those skilled in this art that modifications without departing from the spirit and concept of the invention shall also fall within the scope of the appended claims of the present invention.

What is claimed is:

1. A video graphic array (VGA) device, said device comprises:
a 2D/3D processing engine to deal with input graphic/text data; and
a decompressing processing engine to deal with decompressing of input video compressed data;
said device is characterized by that: a scaling circuit is common to said 2D/3D processing engine and said decompressing processing engine to respectively receive data processed by said 2D/3D processing engine and data processed by said decompressing processing engine.

2. The VGA device as in claim 1, wherein said device further comprises a multiplexer, an input end of said multiplexer is connected to an output end of said 2D/3D processing engine and an output end of said decompressing processing engine respectively, an output end of said multiplexer is connected to an input end of said scaling circuit.

3. The VGA device as in claim 1, wherein said video compressed data are one kind from the three including MPEG1 video compressed data, MPEG2 video compressed data and MPEG4 video compressed data.

4. The VGA device as in claim 1, wherein said graphic/text data are data generated from an application program of a game.

5. The VGA device as in claim 1, wherein said graphic/text data are data generated from an application program written by Direct X of the Microsoft Company.

6. The VGA device as in claim 1, wherein said graphic/text data are data generated from an application program of document processing.

7. The VGA device as in claim 1, wherein said graphic/text data are data generated from an application program of graphic processing.
